(19) United States
(12) Patent Application Publication
(10) Pub. No.: US 2026/0135580 A1
(43) Pub. Date: May 14, 2026

(54) FREQUENCY HOPPING PHASE CORRECTION

(71) Applicant: MOTOROLA SOLUTIONS, INC., Chicago, IL (US)

(72) Inventors: Gareth Harvey, Atwell (AU); Evan M. McAuliffe, Perth (AU)

(21) Appl. No.: 18/944,594

(22) Filed: Nov. 12, 2024

(51) Int. Cl. H04B 1/10; H04B 1/40

(52) U.S. Cl. CPC H04B 1/1027; H04B 1/40

(57) ABSTRACT

A device, system, and method providing frequency hopping phase correction is disclosed. Examples provide a receiver radio device including a receiver circuit with an electronic processor configured to operate according to a frequency hopping scheme having a predefined number of hops per second. The electronic processor receives, from a transmitter radio device, a transmission including an audio signal and a position signal, and determines, based on the position signal, a position of the transmitter radio device. Based on the position of the transmitter radio device, the electronic processor determines a distance between the receiver radio device and the transmitter radio device, and determines a propagation delay of the transmission based on the distance between the receiver radio device and the transmitter radio device. The electronic processor adjusts a frequency hop timing of the frequency hopping scheme according to the propagation delay to reduce a phase transient of the audio signal.

### BACKGROUND

Examples described herein relate to frequency hopping in radio devices.

### BRIEF DESCRIPTION OF THE DRAWINGS

FIG. 1 illustrates a radio communication system, according to some examples.

FIG. 2A is a block diagram of a radio device, according to some examples.

FIG. 2B is a block diagram of a radio device, according to some examples.

FIG. 3A is a graph of a frequency change delay between a transmitted signal and a received signal, according to some examples.

FIG. 3B is a graph of phases of a transmitted signal and a received signal, according to some examples.

FIG. 3C is a graph of phase differences in a received radio signal, according to some examples.

FIG. 3D is a graph of a decoded radio signal, according to some examples.

FIG. 4 is a flowchart of a method for performing phase correction in a frequency hopping scheme, according to some examples.

FIG. 5 is a flowchart of a method for performing phase correction in a frequency hopping scheme, according to some examples.

FIG. 6 illustrates a workflow for transmitting a position signal, according to some examples.

FIG. 7 illustrates a workflow for transmitting a position signal, according to some examples.

FIG. 8 is a flowchart illustrates a method for transmitting a position signal, according to some examples.

FIG. 9 illustrates a workflow for performing phase correction in a frequency hopping scheme, according to some examples.

FIG. 10 illustrates a radio communication system, according to some examples.

Skilled artisans will appreciate that elements in the figures are illustrated for simplicity and clarity and have not necessarily been drawn to scale. For example, the dimensions of some of the elements in the figures may be exaggerated relative to other elements to help improve understanding of examples of the present disclosure.

The system, apparatus, and method components have been represented where appropriate by conventional symbols in the drawings, showing only those specific details that are pertinent to understanding the examples of the present disclosure so as not to obscure the disclosure with details that will be readily apparent to those of ordinary skill in the art having the benefit of the description herein.

### DETAILED DESCRIPTION

Frequency hopping is a technique implemented by some radio devices to reduce the probability of a bad actor jamming or eavesdropping on communications between the radio devices. Frequency hopping is performed by rapidly changing, or hopping, transmission frequencies in an encrypted pattern that is known to both the transmitting radio device and the receiving radio device. In some examples, the transmission frequencies span across 4 megahertz (MHz) of bandwidth at up to 300 hops per second.

An unwanted consequence of hopping across a large frequency range is the phase transitions at the receiver that are caused by the propagation time of the transmitted signal. Even when frequency hops are synchronized between the transmitter and the receiver, the finite time it takes for the signal to propagate between the transmitter and the receiver may manifest as a sharp phase transient at the receiver due to the distance the signal travels and changing wavelengths. In analog frequency modulation (FM) decoders, the frequency detector in the receiving radio device locks onto the new phase of the incoming signal, producing loud and unpleasant spikes in the received audio.

Thus, there is a need for a frequency hopping technique that reduces the phase transient associated with the change in frequencies. One example provides a receiver radio device including: a receiver circuit including an electronic processor configured to operate according to a frequency hopping scheme having a predefined number of hops per second, receive, from a transmitter radio device, a transmission including an audio signal and a position signal, determine, based on the position signal, a position of the transmitter radio device, based on the position of the transmitter radio device, determine a distance between the receiver radio device and the transmitter radio device, determine a propagation delay of the transmission based on the distance between the receiver radio device and the transmitter radio device, and, during reception of the audio signal, adjust a frequency hop timing of the frequency hopping scheme according to the propagation delay to reduce a phase transient of the audio signal.

In some aspects, the electronic processor is configured to determine the propagation delay according to the equation t = d / c, where t is the propagation delay, d is the distance between the receiver radio device and the transmitter radio device, and c is the speed of light.

In some aspects, in the transmission, the position signal is received as a preamble to the audio signal.

In some aspects, the position signal is a 500 baud rate signal.

In some aspects, the position signal is an encrypted global positioning system (GPS) signal.

In some aspects, the encrypted GPS signal is a truncated GPS signal.

In some aspects, in the transmission, the position signal is received simultaneously with the audio signal, and the audio signal is a higher frequency signal than the position signal.

In some aspects, the transmission further includes a 3 kilohertz (kHz) squelch tone.

In some aspects, the position signal is a 100 baud rate signal.

In some aspects, the position signal is repeatedly received during reception of the audio signal.

In some aspects, the predefined number of hops per second is between 100 hops per second and 300 hops per second.

In some aspects, the position signal is a first position signal received, at a first baud rate, as a preamble to the audio signal, the transmission further includes a second position signal received, at a second baud rate lower than the first baud rate, simultaneously with the audio signal.

Another example provides a radio communication system including: a first radio device including a receiver circuit configured to operate according to a frequency hopping scheme having a predefined number of hops per second; and a second radio device including a position sensor and a transmitter circuit having an electronic processor configured to detect a trigger to begin a transmission over a radio frequency (RF) network, in response to detecting the trigger, determine a position of the second radio device based on an output of the position sensor, and transmit, according to the frequency hopping scheme, a position signal indicative of the position of the second radio device and an audio signal over the RF network, wherein reception of the transmission by the first radio device causes the receiver circuit of the first radio device to adjust a frequency hop timing of the frequency hopping scheme at the first radio device based on the position of the second radio device indicated by the position signal.

In some aspects, the position signal is a first position signal transmitted, at a first baud rate, by the electronic processor as a preamble to the audio signal, and the electronic processor is further configured to transmit a second position signal at a second baud rate simultaneously with the audio signal, the second baud rate being lower than the first baud rate.

In some aspects, the electronic processor is further configured to transmit a squelch tone simultaneously with the second position signal and the audio signal.

In some aspects, the electronic processor is configured to repeatedly transmit the second position signal during transmission of the audio signal.

In some aspects, the electronic processor is further configured to encrypt the position signal for transmission.

In some aspects, the receiver circuit of the first radio device is configured to adjust the frequency hop timing at the first radio device according to the equation t = d / c, where t is an offset for adjusting the frequency hop timing, d is a distance between the first radio device and the second radio device determined based on the position signal, and c is the speed of light.

Another example provides a method for reducing phase transients in a receiver radio device that implements a frequency hopping scheme having a predefined number of hops per second. The method includes: receiving, from a transmitter radio device, a transmission including an audio signal and a position signal; decode the position signal to determine a position of the transmitter radio device; based on the position of the transmitter radio device and an output from a position sensor of the receiver radio device, determining a distance between the receiver radio device and the transmitter radio device; determining a propagation delay of the transmission based on the distance between the receiver radio device and the transmitter radio device; and, during reception of the audio signal, adjusting a frequency hop timing of the frequency hopping scheme according to the propagation delay.

In some aspects, the position signal is a first position signal received, at a first baud rate, as a preamble to the audio signal, and the transmission further includes a second position signal received, at a second baud rate lower than the first baud rate, simultaneously with the audio signal.

Examples are herein described with reference to flowchart illustrations and/or block diagrams of methods, apparatus (systems) and computer program products according to examples. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some examples, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or example discussed in this specification can be implemented or combined with any part of any other aspect or example discussed in this specification.

Further advantages and features consistent with this disclosure will be set forth in the following detailed description, with reference to the figures.

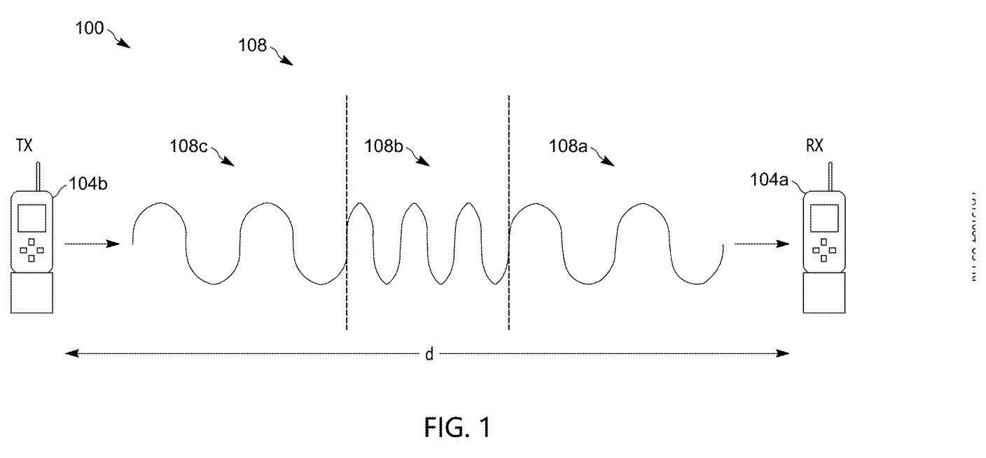

Referring now to the drawings, FIG. 1 illustrates a communication system 100, according to some examples. The communication system 100 includes a plurality of radio devices 104 (e.g., a first radio device 104a and a second radio device 104b). While two radio devices 104a, 104b are illustrated in FIG. 1 for simplicity, the system 100 may include more than two radio devices 104a, 104b. For simplicity, the first radio device 104a may be described herein as a receiver radio device 104a and the second radio device 104b may be described herein as a transmitter radio device 104b. However, both the first radio device 104a and the second radio device 104b may be operable to transmit and receive radio signals between one another.

The radio devices 104 communicate with one another over a radio-frequency (RF) network (e.g., a land mobile radio (LMR) network). In operation, the transmitter radio device 104b is spaced distance d apart from the receiver radio device 104a. Accordingly, a radio signal 108 transmitted by the transmitter radio device 104b propagates over the distance d to the receiver radio device 104a. The distance d spanning between the transmitter radio device 104b and the receiver radio device 104a may change during operation of the plurality of radio devices 104. For example, the receiver radio device 104a and the transmitter radio device 104b may be mobile radios.

The radio devices 104 may transmit and receive radio signals (e.g., the radio signal 108) according to one or more suitable communication protocols. For example, the radio devices 104 may operate according the Project 25 (P25) standard defined by the Association of Public Safety Communications Officials International (APCO), the TETRA standard defined by the European Telecommunication Standards Institute (ETSI), the Digital Private Mobile Radio (dPMR) standard also defined by the ETSI, the Digital Mobile Radio (DMR) standard also defined by the ESI, LTE-Advanced or LTE-Advanced Pro compliant with, for example, the 3GPP TS 36 specification series, or the 5G (including a network architecture compliant with, for example, the 3GPP TS 23 specification series and a new radio (NR) air interface compliant with the 3GPP TS 38 specification series) standard, among other possibilities.

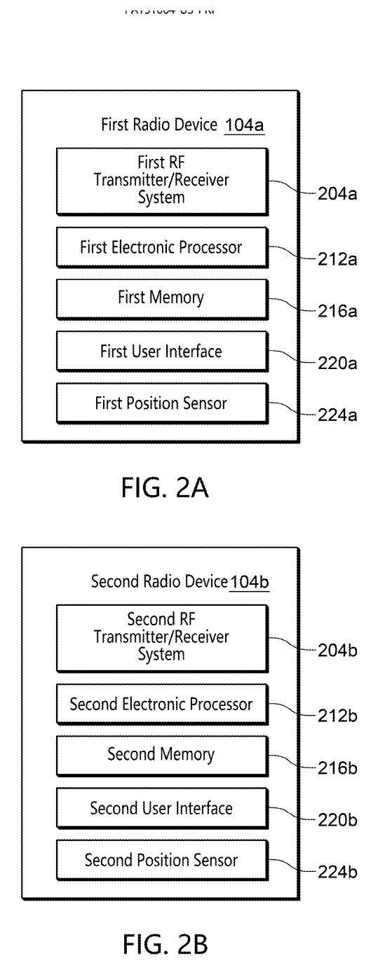

FIG. 2A schematically illustrates the receiver radio device 104a, according to some examples. In the example illustrated in FIG. 2A, the receiver radio device 104a includes a first RF transmitter/receiver system 204a (e.g., including a receiver circuit and a transmitter circuit) configured to transmit and receive radio signals (e.g., the radio signal 108) in the communication system 100. The receiver radio device 104a also includes a first electronic processor 212a (i.e., one or more first electronic processors 212a) configured to control operation of the receiver radio device 104a. A first memory 216a stores information related to operation of the receiver radio device 104a, such as software or program instructions that, when executed by the first electronic processor 212a, cause the first electronic processor 212a to perform, among other things, some or all of the methods described herein. The first memory 216a may further store frequency hopping protocols for operating according to a frequency hopping scheme.

The receiver radio device 104a further includes a first user interface 220a. The first user interface 220a includes, among other things, a microphone for receiving voice data from a user of the receiver radio device 104a to be transmitted using the first RF transmitter system 204a. The first user interface 220a may also include a speaker for outputting, to the user, sound data received (e.g., from the transmitter radio device 104b) via the first RF transmitter system 204a. The first user interface 220a may further include one or more buttons, knobs, dials, or the like for controlling operation of the receiver radio device 104a (e.g., a push-to-talk button, a volume dial, etc.).

The receiver radio device 104a also includes a first position sensor 224a (e.g., a global positioning system (GPS) sensor) configured to detect a location of the receiver radio device 104a and output the detected location to the first electronic processor 212a. For simplicity, the first electronic processor 212a may otherwise be referred to herein as the receiver electronic processor 212a.

FIG. 2B schematically illustrates the transmitter radio device 104b, according to some examples. In the example illustrated in FIG. 2B, the transmitter radio device 104b includes a second RF transmitter/receiver system 204b (e.g., including a receiver circuit and a transmitter circuit) configured to transmit and receive radio signals (e.g., the radio signal 108) in the communication system 100. The transmitter radio device 104b also includes a second electronic processor 212b (i.e., one or more second electronic processors 212b) configured to control operation of the transmitter radio device 104b. A second memory 216b stores information related to operation of the transmitter radio device 104b, such as software or program instructions that, when executed by the second electronic processor 212b, cause the second electronic processor 212b to perform, among other things, some or all of the methods described herein. The second memory 216b may further store frequency hopping protocols for operating according to a frequency hopping scheme.

The transmitter radio device 104b further includes a second user interface 220b. The second user interface 220b includes, among other things, a microphone for receiving voice data from a user of the transmitter radio device 104b to be transmitted using the second RF transmitter/receiver system 204b. The second user interface 220b may also include a speaker for outputting, to the user, sound data received (e.g., from the receiver radio device 104a) via the second RF transmitter/receiver system 204b. The second user interface 220b may further include one or more buttons, knobs, dials, or the like for controlling operation of the transmitter radio device 104b (e.g., a push-to-talk button, a volume dial, etc.).

The transmitter radio device 104b also includes a second position sensor 224b (e.g., a global positioning system (GPS) sensor) configured to detect a location of the transmitter radio device 104b and output the detected location to the second electronic processor 212b. For simplicity, the second electronic processor 212b may otherwise be referred to herein as the transmitter electronic processor 212b.

Referring again to FIG. 1, the transmitter radio device 104b and the receiver radio device 104a are configured to operate according to a frequency hopping scheme having, for example, a predefined number of frequency hops per second. For example, during transmission of the radio signal 108, the transmitter radio device 104b changes the transmit frequency in pattern known to both the transmitter radio device 104b and the receiver radio device 104a (e.g., a pattern stored in the respective memories 216a, 216b of the transmitter radio device 104b and receiver radio device 104a). For example, the frequency hopping scheme may have 100 hops per second, 200 hops per seconds, 300 hops per second, or another predefined number of hops per second. For example, during a transmission, the transmitter radio device 104b may transmit a first portion 108a of the radio signal 108 at a first frequency, execute a first frequency hop, transmit a second portion 108b of the radio signal 108 at a second frequency different from the first frequency, execute a second frequency hop, and transmit a third portion 108c of the radio signal at a third frequency different from the second frequency. Because the receiver radio device 104a operates according to the same frequency hopping scheme as the transmitter radio device 104b, the receiver radio device 104a executes the first and second frequency hops at the same time as the transmitter radio device 104b to receive the transmitted radio signal 108.

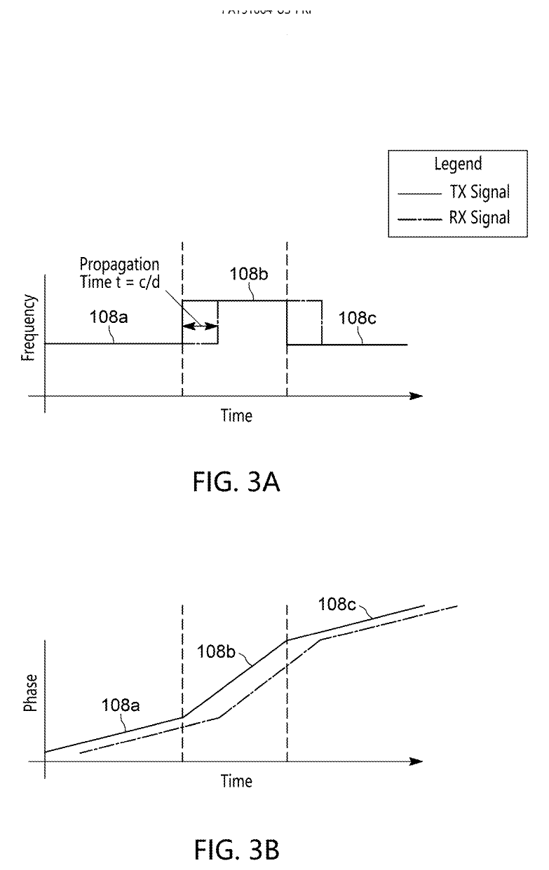

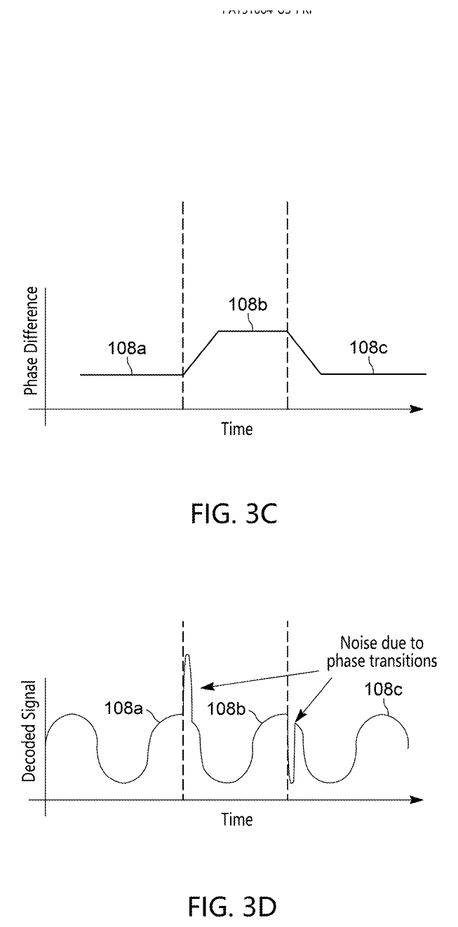

As described above, reception of the radio signal 108 by the receiver radio device 104a experiences a propagation delay as the radio signal 108 travels the propagation distance d from the transmitter radio device 104b to the receiver radio device 104a. However, in conventional radio communication systems, the timing of the frequency hops executed by a receiver radio device does not take into account this propagation delay of the radio signal 108. For example, FIG. 3A illustrates the frequency change delay between transmission of the radio signal 108 (e.g., TX signal) by the transmitter radio device 104b and reception of the radio signal 108 (e.g., RX signal) by the receiver radio device 104a. As illustrated in FIG. 3A, the propagation delay between the transmitted signal and the received signal is dependent on the speed at which the signal propagates (e.g., the speed of light) and distance d between the transmitter radio device 104b and the receiver radio device 104a. As a result of this delay, the timing of the frequency hop in the received signal is different from the timing of the frequency in the transmitted signal. Because the receiver changes frequency before the received signal changes frequency, the propagation delay therefore manifests at the receiver as a sharp phase transient.

For example, FIG. 3B illustrates the phases of the transmitted signal and the received signal, respectively, and FIG. 3C illustrated the phase differences (e.g., the phase transitions) detected by a receiver of the radio signal 108. FIG. 3D illustrates an example of the radio signal 108 decoded at a receiver circuit. As illustrated in FIG. 3D, the decoded signal experiences significant noise at a timing corresponding to the phase transitions of the radio signal 108.

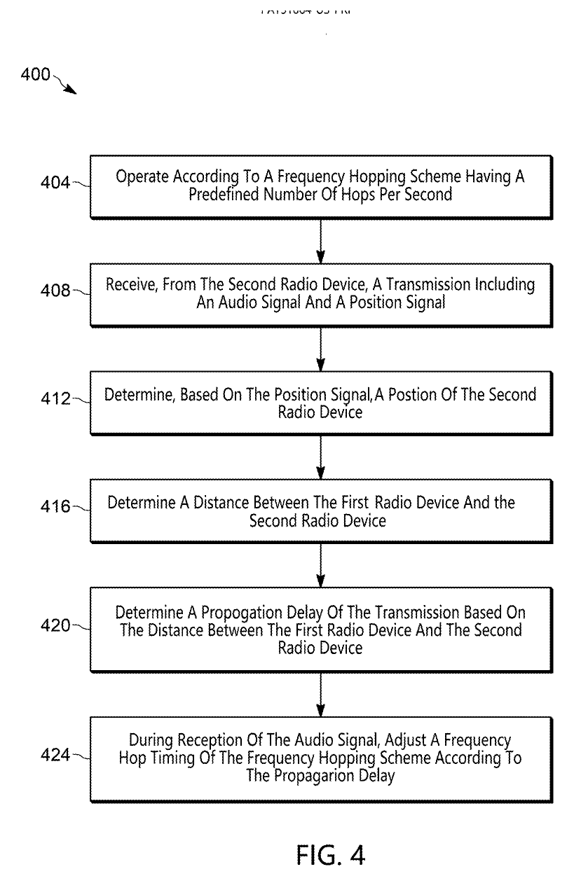

Therefore, FIG. 4 illustrates an example method 400 for correcting the phase transient in a frequency hopping scheme. The method 400 is executed by, for example, the receiver electronic processor 212a of the receiver radio device 104a in conjunction with other components of the receiver radio device 104a. The method 400 includes operating the receiver radio device 104a according to a frequency hopping scheme having a predefined number of hops per second (at block 404). For example, the frequency hopping scheme may have 100 hops per second, 200 hops per seconds, 300 hops per second, or another predefined number of hops per second. In some instances, the receiver electronic processor 212a may selectively operate the receiver radio device 104a in a low-rate mode having 100 hops per second or a high-rate mode having 300 hops per second.

The receiver electronic processor 212a receives, from the transmitter radio device 104b, a transmission including an audio signal and a position signal (at block 408). The position signal is, for example, an encrypted GPS signal indicative of an approximate location of the transmitter radio device 104b. In some instances, the encrypted position signal is a truncated GPS signal that indicates the position of the transmitter radio device 104b within a predetermined distance of accuracy, such as, for example, within approximately 100 meters of accuracy, within approximately 50 meters of accuracy, within approximately 25 meters of accuracy, or the like.

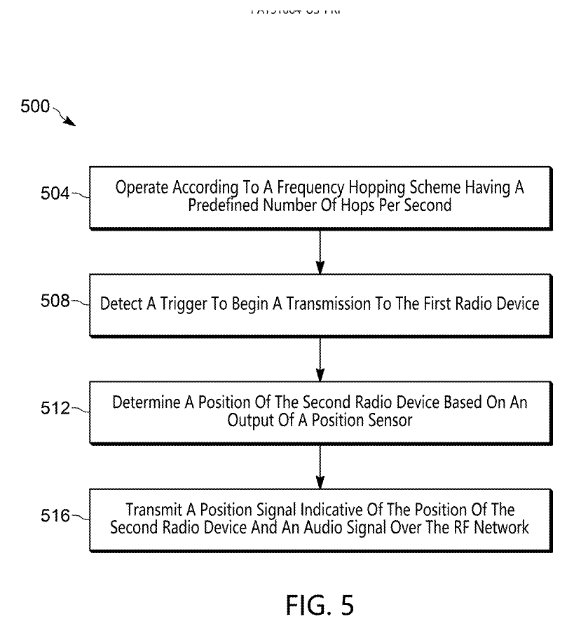

The audio signal included in the transmission is, for example, a communication to the receiver radio device 104a from the transmitter radio device 104b. For example, FIG. 5 illustrates a method 500 executed by the transmitter electronic processor 212b in conjunction with other components of the transmitter radio device 104b. The 500 method includes operating, with the transmitter electronic processor 212b, the transmitter radio device 104b according to the frequency hopping scheme having the predefined number of hops per second (at block 504). As described above, the receiver radio device 104a and the transmitter radio device 104b each store the encryption pattern of the frequency hopping scheme to communicate with one another according to the scheme.

The transmitter electronic processor 212b may detect a trigger to begin a transmission to the receiver radio device 104a over an RF network (e.g., an LMR network) (at block 508). The trigger may include actuation of a button, switch, or other input mechanism (e.g., a push-to-talk button) of the user interface 220b of the transmitter radio device 104b. In response to detecting the trigger, the transmitter electronic processor 212b determines a position (e.g., a GPS position) of the transmitter radio device 104b based on an output of the second position sensor 224b included in the transmitter radio device 104b (at block 508). In some instances, the transmitter electronic processor 212b determines the position of the transmitter radio device 104b periodically.

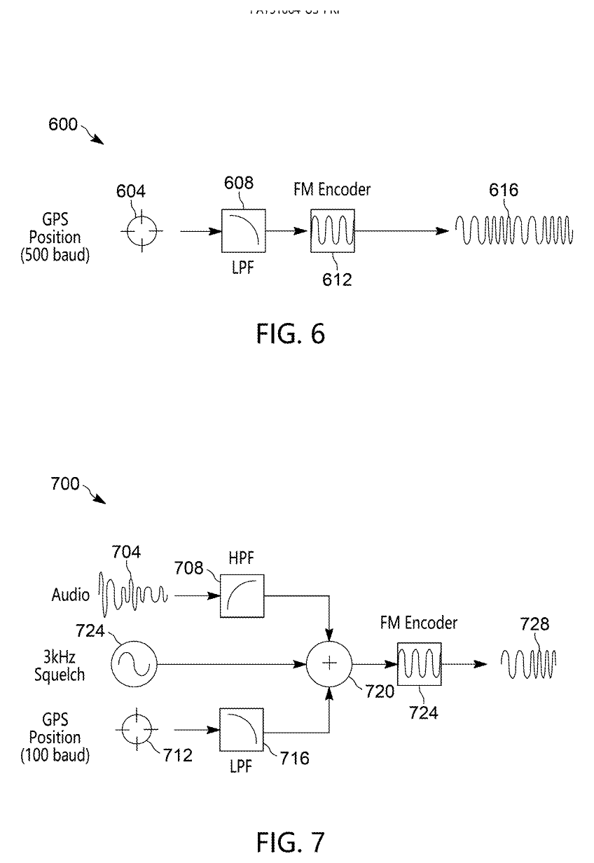

The transmitter electronic processor 212b transmits, according to the frequency hopping scheme, a position signal indicative of the position of the transmitter radio device 104b and an audio signal to the receiver radio device 104a over the RF network (at block 512). The audio signal is, for example, based on audio input received via a microphone of the transmitter radio device 104b. In some instances, the transmitter electronic processor 212b transmits the position signal as a preamble to the audio signal. For example, FIG. 6 illustrates an example workflow 600 for performing preamble transmission of the position signal. As illustrated in FIG. 6, a transmitter circuit of the second transmitter/receiver system 204b receives a position signal (e.g., from the second position sensor 224b) (at block 604) and filters (e.g., using a low pass filter) the received position signal (at block 608). The transmitter circuit encodes the filtered position signal (e.g., using a frequency modulation (FM) encoder) (at block 612) and outputs the encoded position signal for transmission to the receiver radio device 104a (at block 616). In some instances, during preamble transmission, the position signal is transmitted as a high baud rate signal (e.g., a 500 baud rate signal).

In some instances, the transmitter electronic processor 212b transmits the position signal simultaneously with the audio signal (e.g., at block 516 of the method 500). For example, FIG. 7 illustrates an example workflow 700 for performing simultaneous transmission of the position signal and the audio signal. In instances where the position signal is transmitted simultaneously with the audio signal, the audio signal is transmitted at a higher frequency than the position signal. For example, as illustrated in FIG. 7, a transmitter circuit of the second transmitter/receiver system 204b receives an audio signal, for example via a microphone of the second user interface 220b (at block 704), and filters (e.g., using a high pass filter) the received audio signal (at block 708). The transmitter circuit of the second transmitter/receiver system 204b also receives (e.g., from the second position sensor position 224b) the GPS signal indicating the position of the transmitter radio device 104b (at block 712) and filters (e.g., using a low pass filter) the received GPS signal (at block 716). The transmitter circuit combines the filtered audio signal and the filtered GPS signal (at block 720), encodes the combined signal using an FM encoder (at block 724), and outputs the combined RF signal for transmission (at block 728).

In some instances, the transmitter circuit also generates a squelch tone signal (e.g., a 3 kilohertz (kHz) squelch tone signal) (at block 728) and combines the squelch tone signal with the filtered audio signal and the filtered GPS signal (at block 720), encodes the combined signal (at block 724), and outputs the combined signal for transmission (at block 728).

During simultaneous transmission according to, for example, the workflow 700, the position signal is transmitted at a lower baud rate than during preamble transmission according to the workflow 600. For example, during simultaneous transmission of the position signal and the audio signal, the position signal is transmitted as a low baud rate signal (e.g., a 100 baud rate signal). In this manner, the position signal can be filtered out by a receiver circuit that receives the transmission including the position signal and the audio signal.

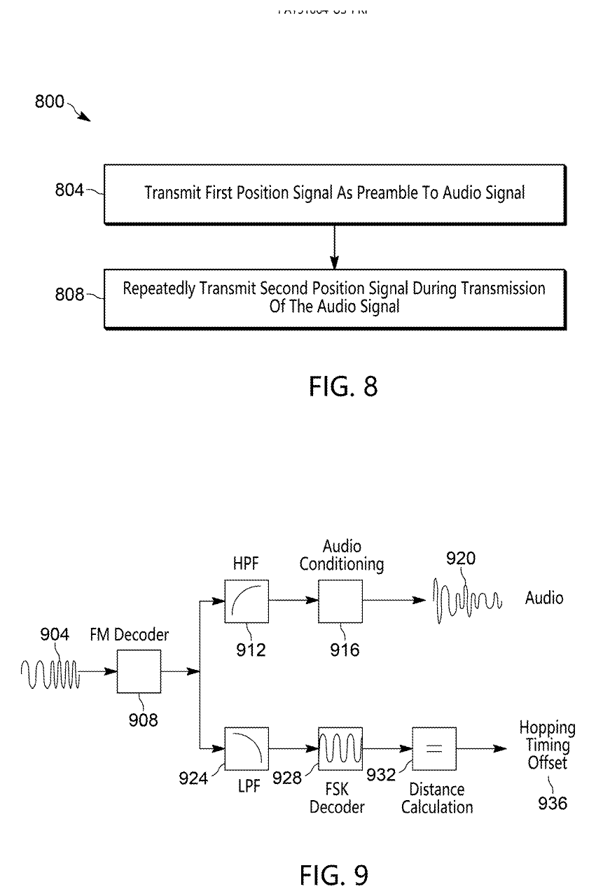

In some instances, the transmitter electronic processor 212b transmits a first position signal to the receiver radio device 104a as a preamble to the audio signal and transmits a second position signal to the receiver radio device 104a simultaneously with the audio signal. For example, FIG. 8 illustrates an example method 800, executed by the transmitter electronic processor 212b, for transmitting a position signal and an audio signal to the receiver radio device 104a. The method 800 includes transmitting a first position signal as a preamble to the audio signal, for example, according to the workflow 600 described above with respect to FIG. 6 (at block 804). As described above, the first position signal may be an encrypted and truncated GPS signal indicative of an approximate location of the transmitter radio device 104b. However, in some instances, the first position signal is not truncated. The transmitter electronic processor 212b transmits the first position signal at a first baud rate (e.g., a high baud rate).

In response to transmitting the first position signal, the transmitter electronic processor 212b repeatedly transmits a second position signal during (e.g., simultaneous with) transmission of the audio signal, for example according to the workflow 700 described above with respect to FIG. 7 (at block 808). The transmitter electronic processor 212b transmits the first position signal at a second baud rate that is lower than the first baud rate to allow a receiver of the transmission to filter the second position signal from the simultaneously transmitted audio signal. In some instances, the transmitter electronic processor 212b repeatedly transmits the second position signal at the lower baud rate until the transmitter electronic processor 212b detects a trigger to end the audio transmission (e.g., detecting a release of a push to talk button or the like).

In some instances, the position indicated by the first position signal is the same as the position indicated by the second position signal. For example, the transmitter electronic processor 212b may only determine the position of the transmitter radio device 104b once per transmission.

By repeatedly transmitting the second position signal during transmission of the audio signal, the transmitter electronic processor 212b enables a receiver radio device (e.g., the receiver radio device 104a) that arrives late to the transmission (e.g., joins a channel or talkgroup after the preamble has been transmitted) to still receive a signal indicating the position of the transmitter radio device 104b.

Referring again to the method 400 of FIG. 4, the receiver electronic processor 212a determines, based on the position signal included in the transmission and received from the transmitter radio device 104b, a position of the second radio device 104b (at block 412). As described above, the position signal may be received by the receiver electronic processor 212a as a preamble to the audio signal and/or simultaneously with the audio signal.

Based on the determined position of the transmitter radio device 104b, the receiver electronic processor 212a determines the distance d (e.g., the approximate distance d) between the transmitter radio device 104b and the receiver radio device 104a (at block 416). The receiver electronic processor 212a determines the distance d using, for example, an output of the first position sensor 224a included in the receiver radio device 104a. For example, the receiver radio device 104a compares the position of the second radio device 104b indicated by the received position signal with a position of the first radio device 104a indicated by the output of the first position sensor 224a to determine the distance d between the transmitter radio device 104b and the receiver radio device104a.

The receiver electronic processor 212a determines a propagation delay of the transmission based on the determined distance d between the receiver radio device 104a and the transmitter radio device 104b (at block 420). The receiver electronic processor 212a determines the propagation delay according to, for example, the equation t = d / c, where t is the propagation delay, d is the distance between the receiver radio device 104a and the transmitter radio device 104b, and c is the speed of light (e.g., 3x10⁸ meters per second (m/s)).

In response to determining the propagation delay and during reception of the audio signal included in the transmission, the receiver electronic processor 212a adjusts a hop timing of the frequency hopping scheme according to the propagation delay to reduce a phase transient of the received audio signal (at block 424). For example, for each scheduled frequency hop event, the receiver electronic processor 212a updates the hop event timing with an offset equal to the determined propagation delay. The receiver electronic processor 212a may update the hop event timing by, for example, modifying a timer associated with the frequency hopping scheme. In this manner, the receiver radio device 104a hops frequencies at a timing that corresponds with a frequency change of the received audio signal (e.g., at the receiver radio device 104a) rather than at a timing that corresponds with the transmitted audio signal (e.g., at the transmitter radio device 104b).

The receiver electronic processor 212a adjusts the hop timing locally (e.g., only within the receiver radio device 104a) such that the adjustment of the timing does not affect a timing at which the transmitter radio device 104b or other receiver radio devices hop frequencies. Additionally, the receiver electronic processor 212a adjusts the frequency hop timing without modifying a local clock of the receiver radio device 104a.

In some instances, the receiver electronic processor 212a resets the hop timings of the frequency hopping scheme to a default state (e.g., having no offset) in response to detecting that the transmission received from the transmitter radio device 104b has ended.

FIG. 9 illustrates an example workflow 900 for determining the hop timing offset during, for example, a simultaneous reception of the position signal and the audio signal (e.g., as opposed to a preamble reception of the position signal). As illustrated in FIG. 9, a receiver circuit of the first transmitter/receiver system 204a receives a transmission signal from the transmitter radio device 104b (at block 904) and decodes the transmission signal using an FM decoder (at block 908). The receiver circuit filters the transmission signal using a first filter (e.g., a high pass filter) to isolate the audio signal (at block 912), performs audio conditioning on the audio signal (at block 916), and outputs the audio signal, for example, to a speaker or other audio output mechanism of the receiver radio device 104a (at block 920).

The receiver circuit also filters the received transmission signal using a second filter (e.g., a low pass filter) to isolate the position signal (at block 924) and decodes the position signal (e.g., using a frequency-shift keying (FSK) decoder) (at block 928), calculates the distance between the receiver radio device 104a and the transmitter radio device 104b based on the decoded position (at block 932), and determines a frequency hop timing offset based on the determined distance (at block 936).

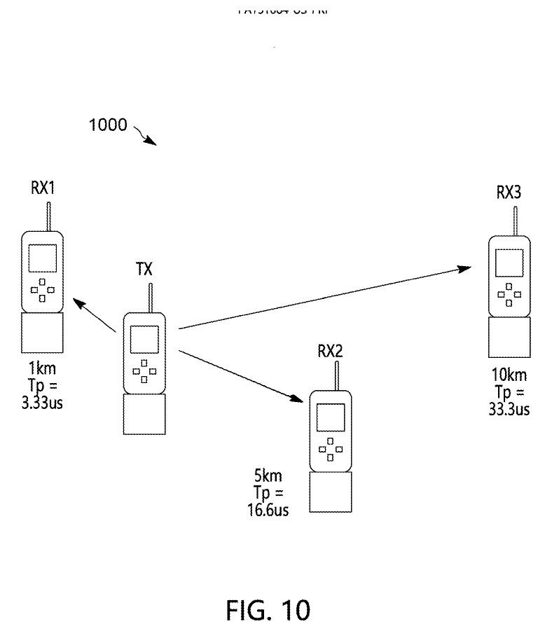

FIG. 10 illustrates an example communication system 1000 that employs the methods described herein. As illustrated in FIG. 10, the communication system 1000 includes a transmitter radio device TX that transmits audio signals to a plurality of receiver radio devices RX1-RX3, each located at different distances from the transmitter radio device TX. Therefore, each receiver radio device RX1-RX3 determines a different hop timing offset for receiving a frequency-hopped transmission from the transmitter radio device TX. For example, the first receiver radio device RX1 that is located one kilometer (km) away from the transmitter radio device TX adjusts a frequency hop timing implemented in the first receiver radio device RX1 by 3.33 microseconds (μs). The second receiver radio device RX2 that is located 5 km away from the transmitter radio device TX adjusts a frequency hop timing implemented in the second receiver radio device RX2 by 16.6 μs. The third receiver radio device RX3 that is located 10 km away from the transmitter radio device adjusts a frequency hop timing implemented in the third receiver radio device RX3 by 33.3 μs.

As should be apparent from this detailed description above, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot implement frequency hopping schemes, among other features and functions set forth herein).

In the foregoing specification, various examples have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises …a,” “has …a,” “includes …a,” “contains …a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if examples described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some examples may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an example can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

The terms “substantially,” “essentially,” “approximately,” “about” or any other version thereof, are defined as being close to as understood by one of ordinary skill in the art, and in one non-limiting example the term is defined to be within 10%, in another example within 5%, in another example within 1% and in another example within 0.5%. The term “one of,” without a more limiting modifier such as “only one of,” and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled,” “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A receiver radio device comprising:
a receiver circuit including an electronic processor configured to
operate according to a frequency hopping scheme having a predefined number of hops per second,
receive, from a transmitter radio device, a transmission including an audio signal and a position signal,
determine, based on the position signal, a position of the transmitter radio device,
based on the position of the transmitter radio device, determine a distance between the receiver radio device and the transmitter radio device,
determine a propagation delay of the transmission based on the distance between the receiver radio device and the transmitter radio device, and
during reception of the audio signal, adjust a frequency hop timing of the frequency hopping scheme according to the propagation delay to reduce a phase transient of the audio signal.

2. The receiver radio device of claim 1, wherein the electronic processor is configured to determine the propagation delay according to the equation t = d / c, where t is the propagation delay, d is the distance between the receiver radio device and the transmitter radio device, and c is the speed of light.

3. The receiver radio device of claim 1, wherein, in the transmission, the position signal is received as a preamble to the audio signal.

4. The receiver radio device of claim 3, wherein the position signal is a 500 baud rate signal.

5. The receiver radio device of claim 1, wherein the position signal is an encrypted global positioning system (GPS) signal.

6. The receiver radio device of claim 5, wherein the encrypted GPS signal is a truncated GPS signal.

7. The receiver radio device of claim 1, wherein
in the transmission, the position signal is received simultaneously with the audio signal, and
the audio signal is a higher frequency signal than the position signal.

8. The receiver radio device of claim 7, wherein the transmission further includes a 3 kilohertz (kHz) squelch tone.

9. The receiver radio device of claim 7, wherein the position signal is a 100 baud rate signal.

10. The receiver radio device of claim 7, wherein, the position signal is repeatedly received during reception of the audio signal.

11. The receiver radio device of claim 1, wherein the predefined number of hops per second is between 100 hops per second and 300 hops per second.

12. The receiver radio device of claim 1, wherein
the position signal is a first position signal received, at a first baud rate, as a preamble to the audio signal,
the transmission further includes a second position signal received, at a second baud rate lower than the first baud rate, simultaneously with the audio signal.

13. A radio communication system comprising:
a first radio device including a receiver circuit configured to operate according to a frequency hopping scheme having a predefined number of hops per second; and
a second radio device including a position sensor and a transmitter circuit having an electronic processor configured to
detect a trigger to begin a transmission over a radio frequency (RF) network,
in response to detecting the trigger, determine a position of the second radio device based on an output of the position sensor, and
transmit, according to the frequency hopping scheme, a position signal indicative of the position of the second radio device and an audio signal over the RF network,
wherein reception of the transmission by the first radio device causes the receiver circuit of the first radio device to adjust a frequency hop timing of the frequency hopping scheme at the first radio device based on the position of the second radio device indicated by the position signal.

14. The radio communication system of claim 13, wherein the position signal is a first position signal transmitted, at a first baud rate, by the electronic processor as a preamble to the audio signal, and the electronic processor is further configured to transmit a second position signal at a second baud rate simultaneously with the audio signal, the second baud rate being lower than the first baud rate.

15. The radio communication system of claim 14, wherein the electronic processor is further configured to transmit a squelch tone simultaneously with the second position signal and the audio signal.

16. The radio communication system of claim 14, wherein the electronic processor is configured to repeatedly transmit the second position signal during transmission of the audio signal.

17. The radio communication system of claim 13, wherein the electronic processor is further configured to encrypt the position signal for transmission.

18. The radio communication system of claim 13, wherein the receiver circuit of the first radio device is configured to adjust the frequency hop timing at the first radio device according to the equation t = d / c, where t is an offset for adjusting the frequency hop timing, d is a distance between the first radio device and the second radio device determined based on the position signal, and c is the speed of light.

19. A method for reducing phase transients in a receiver radio device that implements a frequency hopping scheme having a predefined number of hops per second, the method comprising:
receiving, from a transmitter radio device, a transmission including an audio signal and a position signal;
decode the position signal to determine a position of the transmitter radio device;
based on the position of the transmitter radio device and an output from a position sensor of the receiver radio device, determining a distance between the receiver radio device and the transmitter radio device;
determining a propagation delay of the transmission based on the distance between the receiver radio device and the transmitter radio device; and
during reception of the audio signal, adjusting a frequency hop timing of the frequency hopping scheme according to the propagation delay.

20. The method of claim 19, wherein the position signal is a first position signal received, at a first baud rate, as a preamble to the audio signal,
the transmission further includes a second position signal received, at a second baud rate lower than the first baud rate, simultaneously with the audio signal.
